(19) United States
(12) Patent Application Publication
(10) Pub. No.: US 2025/0373933 A1
(43) Pub. Date: Dec. 4, 2025

(54) CONTROL APPARATUS, IMAGE CAPTURE APPARATUS AND CONTROL METHOD

(71) Applicant: CANON KABUSHIKI KAISHA, Tokyo (JP)

(72) Inventors: TOSHIHIKO TOMOSADA, Kanagawa (JP); HIDEYASU HONGU, Kanagawa (JP); ATSUSHI KATO, Kanagawa (JP); YUDAI FUKUZAWA, Tokyo (JP)

(21) Appl. No.: 19/217,505

(22) Filed: May 23, 2025

(30) Foreign Application Priority Data
May 31, 2024 (JP) 2024-089246

(51) Int. Cl. H04N 23/63; H04N 23/611; H04N 23/67

(52) U.S. Cl. CPC H04N 23/635; H04N 23/611; H04N 23/675

(57) ABSTRACT

A control apparatus performs automatic focus control on a predetermined subject selected based on a user operation for changing an in-focus state of a subject included in the image, and performs control so as to superimpose and display, on the predetermined subject, first information indicating that the predetermined subject is a target for the automatic focus control. The automatic focus control is switchable to any of a plurality of automatic focus controls including tracking AF that causes a subject of a target for the automatic focus control to be always in an in-focus state. When the automatic focus control is set to the tracking AF, the control apparatus executes the tracking AF on the predetermined subject after the user operation ends.

### BACKGROUND

### Field of the Technology

The present disclosure relates to a focus control.

### Description of the Related Art

Japanese Patent No. 5474528 describes a method of determining, after a manual focus operation by a user ends, a region closest to focus as a main subject region and continuously performing automatic focus (AF) control on the main subject region. In Japanese Patent No. 5474528, when there is a detected subject such as a person at an in-focus position, AF control is executed on the person. When there are a plurality of persons, AF control is executed on the person decided according to a priority order. When no person is detected, AF control is executed with reference to a range of the same color in the range of the in-focus position.

When shooting as a video production style, the user may operate (focus, zoom, diaphragm, and the like) the lens with the left hand and operate (panning, tilting, start/stop of recording, and the like) the camera with the right hand. In this case, when the user performs a manual focus operation on the lens with the left hand, a region intended by the user is decided, and the main subject can be selected.

In Japanese Patent No. 5474528, the user cannot check a subject that is a target for AF control during manual focus operation. In Japanese Patent No. 5474528, since an AF frame or the like is not displayed on the main subject determined by the camera, it is difficult for the user to check the main subject after the manual focus operation ends and judge which subject AF is to be executed for.

### SUMMARY

The present disclosure has been made in consideration of the aforementioned problems, and realizes techniques that enable easy grasp of a main subject that is a target for AF control selected by a user operation.

The present disclosure is directed to a control apparatus comprising: a display control unit that performs control so as to display a captured image on a display unit; and a control unit that performs automatic focus control on a predetermined subject selected based on a user operation for changing an in-focus state of a subject included in the image, wherein the display control unit performs control so as to superimpose and display, on the predetermined subject, first information indicating that the predetermined subject is a target for the automatic focus control, the automatic focus control is switchable to any of a plurality of automatic focus controls including tracking AF that causes a subject of a target for the automatic focus control to be always in an in-focus state, and when the automatic focus control is set to the tracking AF, the control unit executes the tracking AF on the predetermined subject after the user operation ends.

The present disclosure is directed to a control method of a control apparatus comprising: performing automatic focus control on a predetermined subject selected based on a user operation for changing an in-focus state of a subject included in a captured image; and performing control so as to superimpose and display, on the predetermined subject, first information indicating that the predetermined subject is a target for the automatic focus control.

Features of the present disclosure will become apparent from the following description of embodiments with reference to the attached drawings. The following description of embodiments are described by way of example.

### BRIEF DESCRIPTION OF THE DRAWINGS

The accompanying drawings, which are incorporated in and constitute a part of the specification, illustrate embodiments of the present disclosure, and together with the description, serve to explain the principles of the embodiments.

FIG. 1 is a block diagram illustrating a configuration of an image capture apparatus according to a present embodiment.

FIGS. 2A to 2C are views illustrating a setting method of a ranging region on an imaging screen according to the present embodiment.

FIG. 3 is a view illustrating a setting menu of an AF control mode at the time of a focus operation end according to the present embodiment.

FIGS. 4A and 4B are flowcharts showing focus control processing according to the present embodiment.

FIG. 5 is a flowchart showing focus mode determination processing according to the present embodiment.

FIG. 6 is a flowchart showing AF frame decision processing at the time of subject detection according to the present embodiment.

FIG. 7 is a flowchart showing AF frame decision processing at the time of subject non-detection according to the present embodiment.

FIG. 8 is a flowchart showing focus threshold setting processing at the time of subject non-detection according to the present embodiment.

FIG. 9 is a flowchart showing AF frame display processing at the time of subject detection according to the present embodiment.

FIG. 10 is a flowchart showing AF frame display processing at the time of subject non-detection according to the present embodiment.

FIGS. 11A to 11D are views illustrating a subject region extraction method at the time of subject non-detection according to the present embodiment.

FIG. 12 is a view illustrating a focus threshold setting method at the time of subject non-detection according to the present embodiment.

FIGS. 13A to 13C are views illustrating an AF frame display method at the time of subject detection according to the present embodiment.

FIGS. 14A to 14D are views illustrating an AF frame display method at the time of subject non-detection according to the present embodiment.

### DESCRIPTION OF THE EMBODIMENTS

Hereinafter, embodiments will be described in detail with reference to the attached drawings. Note, the following embodiments are not intended to limit the scope of the claims. Multiple features are described in the embodiments, but it is not the case that all such features are required, and multiple such features may be combined as appropriate. Furthermore, in the attached drawings, the same reference numerals are given to the same or similar configurations, and redundant description thereof is omitted.

Hereinafter, an example in which the image capture apparatus of the present disclosure is applied to a digital video camera will be described, but the image capture apparatus may be applied to another image capture apparatus such as a digital still camera.

### APPARATUS CONFIGURATION

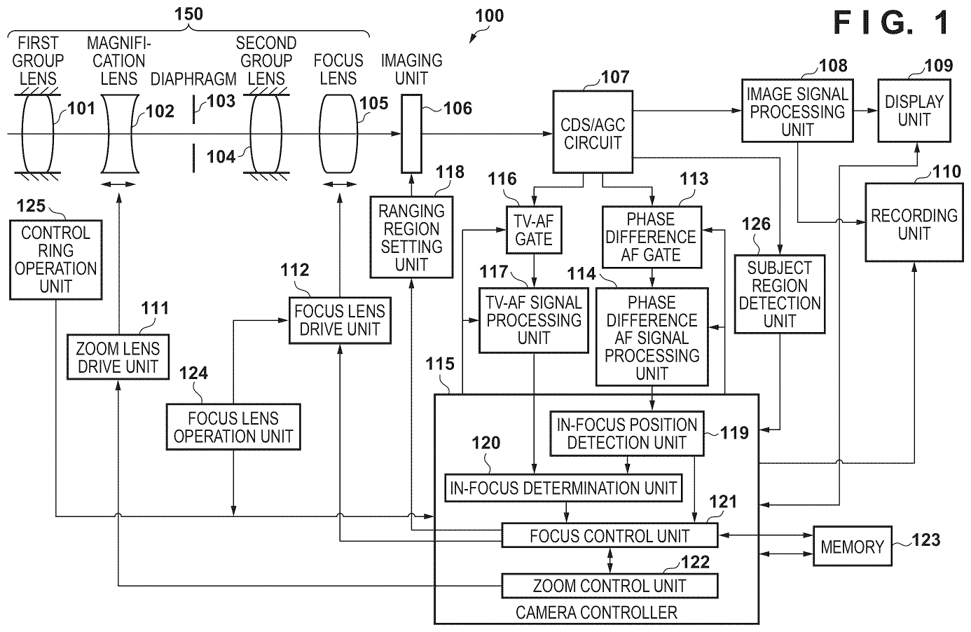

First, a hardware configuration of the image capture apparatus according to the present embodiment will be described with reference to FIG. 1.

FIG. 1 is a block diagram illustrating a hardware configuration of the image capture apparatus according to the present embodiment.

An image capture apparatus 100 includes an image capture optical system 150 for forming a subject image, which is light from a subject. The image capture optical system 150 includes a fixed first group lens 101, a magnification lens 102, a diaphragm 103, a fixed second group lens 104, and a focus compensator lens 105. The camera controller (hereinafter, camera microcomputer) 115 includes an in-focus position detection unit 119, an in-focus determination unit 120, a focus control unit 121, and a zoom control unit 122.

The magnification lens 102 moves in the optical axis direction and performs a magnification operation. The focus compensator lens (hereinafter, focus lens) 105 has a function of correcting movement of a focal plane accompanying a magnification operation and a function of adjusting a focus state. The image capture optical system 150 includes a focus lens operation unit 124 (hereinafter, focus ring). The focus ring 124 is an operation member that is rotatable around the optical axis of the image capture optical system 150 and is operable by the user. When the user operates the focus ring 124 in the shooting mode, the focus lens 105 is moved in the optical axis direction by a focus lens drive unit 112 in accordance with the operation amount of the focus ring 124. Note that information such as a driving amount, a driving speed, and a driving direction of the focus lens 105 corresponding to the rotation amount and the rotation direction of the focus ring 124, which is operation information of the focus ring 124, is output to the camera microcomputer 115. The image capture optical system 150 further includes control ring operation unit (hereinafter, control ring) 125. The control ring 125 is an operation member that is rotatable around the optical axis of the image capture optical system 150 and is operable by the user. When the user operates the control ring 125, the detected subject is switched or the shooting setting (ISO/diaphragm/gain, and the like) is changed in accordance with the operation information of the control ring 125. Note that information such as the rotation amount and the rotation direction of the control ring 125, which is operation information of the control ring 125, is output to the camera microcomputer 115.

An imaging unit 106 includes an image sensor including a photoelectric conversion element such as a CCD or a CMOS and a peripheral circuit that drives the photoelectric conversion element and reads a signal, and photoelectrically converts and outputs, as an electric signal, a subject image in which light passing through the image capture optical system 150 is formed on an on-imaging plane. The image sensor includes a microlens that performs pupil division of an exit pupil of the image capture optical system 150, and the image capture apparatus 100 performs automatic focus (AF) control by an on-imaging plane phase difference method based on a pair of image signals obtained from light fluxes having passed through different pupil regions.

A CSD/AGC circuit 107 includes a CDS circuit that performs correlated double sampling processing for removing reset noise (low frequency) included in an image capture signal output from the imaging unit 106, and an AGC circuit that amplifies and controls, to a certain level, the image capture signal output from the imaging unit 106.

An image signal processing unit 108 executes image processing on the image capture signal output from the CDS/AGC circuit 107 to generate image data.

A display unit 109 includes a display device such as a liquid crystal panel or an organic EL, and displays image data output from the image signal processing unit 108 and also displays setting information at the time of shooting, an AF frame indicating a focus detection region at the time of AF control start described later, and the like.

A recording unit 110 encodes image data output from the image signal processing unit 108 by a moving image compression method such as the MP4 format and records the image data as a moving image file on a recording medium, or decodes a moving image file read from a recording medium. The recording medium is a magnetic tape, an optical disk, a semiconductor memory, or the like. Note that the image capture apparatus 100 according to the present embodiment can generate not only moving image data but also still image data and moving image data combined with audio data.

A zoom lens drive unit 111 includes actuators such as a stepping motor, a DC motor, a vibration type motor, and a voice coil motor for moving the magnification lens 102 in the optical axis direction. The focus lens drive unit 112 includes actuators such as a stepping motor, a DC motor, a vibration type motor, and a voice coil motor for moving the focus lens 105 in the optical axis direction.

A phase difference AF gate 113 passes a first focus detection signal and a second focus detection signal of a pixel corresponding to a focus detection region in the AF frame detected by the on-imaging plane phase difference AF method among pixels in a ranging region set by a ranging region setting unit 118 for phase difference AF described later. Here, the ranging region is also called a focus detection region. Note that although the on-imaging plane phase difference AF will be described in the present embodiment, the present disclosure is not limited to the on-imaging plane phase difference AF, and other focus detection methods may be adopted as long as information regarding the subject distance can be obtained. For example, a time of flight (ToF) method in which a distance is calculated by emitting light (infrared light or laser) and measuring a time until the light hits a subject and is reflected back is considered. A method in which a radio frequency identification (RFID) tag or an ultra-wideband (UWB) tag may be attached to a subject, and an antenna may receive a signal from the tag to specify a position is considered.

The phase difference AF signal processing unit 114 performs correlation calculation based on two focus detection signals that have passed through the phase difference AF gate 113, calculates an image shift amount for each focus detection region, and outputs the image shift amount to the in-focus position detection unit 119 of the camera microcomputer 115.

The camera microcomputer 115 includes a processor (CPU) that performs calculation processing and control processing of the image capture apparatus 100, a nonvolatile memory (ROM) that stores a program executed by the processor, and a work memory (RAM) into which a program read from the nonvolatile memory, constants, variables, and the like for executing the program are loaded. The camera microcomputer 115 controls each component of the image capture apparatus 100 by loading a program stored in the ROM into the RAM and executing the program.

A memory 123 is a flash memory externally attached to expand the memory region of the camera microcomputer 115.

The in-focus position detection unit 119 calculates a defocus amount, which is a shift amount between the current focus position and the in-focus position on the on-imaging plane of the imaging unit 106, from the image shift amount calculated by the phase difference AF signal processing unit 114 by the on-imaging plane phase difference AF method. Then, the in-focus position detection unit 119 outputs the defocus amount to the focus control unit 121 as a ranging result. The in-focus position detection unit 119 converts the defocus amount into the driving amount of the focus lens 105 and outputs the driving amount to the in-focus determination unit 120.

The in-focus determination unit 120 calculates control information for driving the focus lens 105 based on the driving amount of the focus lens 105 received from the in-focus position detection unit 119, and outputs the control information to the focus control unit 121.

The focus control unit 121 controls the focus lens drive unit 112 based on the control information of the focus lens 105 received from the in-focus determination unit 120 to drive the focus lens 105, and executes AF control.

The zoom control unit 122 controls the zoom lens drive unit 111 based on the driving amount and the driving speed of the magnification lens 102 in accordance with the zoom operation by the user to drive the magnification lens 102, and executes zoom control.

Note that the AF method according to the present embodiment is not limited to the on-imaging plane phase difference AF method, and other AF methods may be applied.

A TV-AF gate 116 and a TV-AF signal processing unit 117 in FIG. 1 are components for implementing the TV-AF method other than the on-imaging plane phase difference AF method.

The TV-AF gate 116 outputs, to the TV-AF signal processing unit 117, only an image capture signal of a focus detection region for focus detection by the TV-AF method among image capture signals of all pixels output from the CDS/AGC circuit 107.

The TV-AF signal processing unit 117 applies a known method such as extraction of a specific frequency component using a filter to an image capture signal of a focus detection region for TV-AF (AF frame in the present embodiment) output from the TV-AF gate 116, and generates a TV-AF evaluation value in which sharpness (contrast) of the image is the highest at an in-focus position.

The TV-AF evaluation value is output to the in-focus determination unit 120. The TV-AF evaluation value is output to the focus control unit 121. The focus control unit 121 controls the focus lens drive unit 112 based on the TV-AF evaluation value to drive the focus lens 105, and performs AF control by the TV-AF method.

The ranging region setting unit 118 for phase difference AF sets a pixel group from which the first and second focus detection signals input to the phase difference AF gate 113 are read out among all the pixels of the imaging unit 106. The ranging region setting unit 118 can variably set, in accordance with the subject detection state, a focus detection region for reading a focus detection signal for focus detection by the phase difference AF method.

A subject region detection unit 126 executes known subject detection processing on the image capture signal output from the CDS/AGC circuit 107, and detects a subject existing in an imaging screen corresponding to the image data generated by the image signal processing unit 108. The subject detection processing according to the present embodiment is face detection processing in which the detection target is a face region of a person. For the face region detection processing, for example, there is a method of extracting a skin color region from a gradation color of each pixel represented by image data, and detecting a face based on a matching degree with a contour plate of a face prepared in advance. In addition to that, there is a method of performing face detection by extracting feature points of the face such as an eye, a nose, and a mouth with reference to a known pattern recognition technique. The present embodiment is not limited to specific subject detection processing, and any method may be used. The subject of the detection target is not limited to a person or a face, and may be an animal, an insect, a vehicle, or the like other than a person or a face.

Note that the image capture apparatus 100 according to the present embodiment can switch to any of a plurality of focus modes including an AF mode, an MF mode, and an MF/AF switching mode. The AF mode is a mode for automatically performing focus adjustment of a target subject (main subject) to an in-focus state by AF control. The MF mode is a mode for the user to perform focus adjustment, with manual operation, of the focus ring 124 to bring a desired subject (main subject) into an in-focus state. The MF/AF switching mode is a mode of automatically switching to the AF mode after the end of the operation by the MF mode, and continuously executing the AF control with the subject brought into the in-focus state by the manual focus operation as the main subject.

### Setting Method of Ranging Region

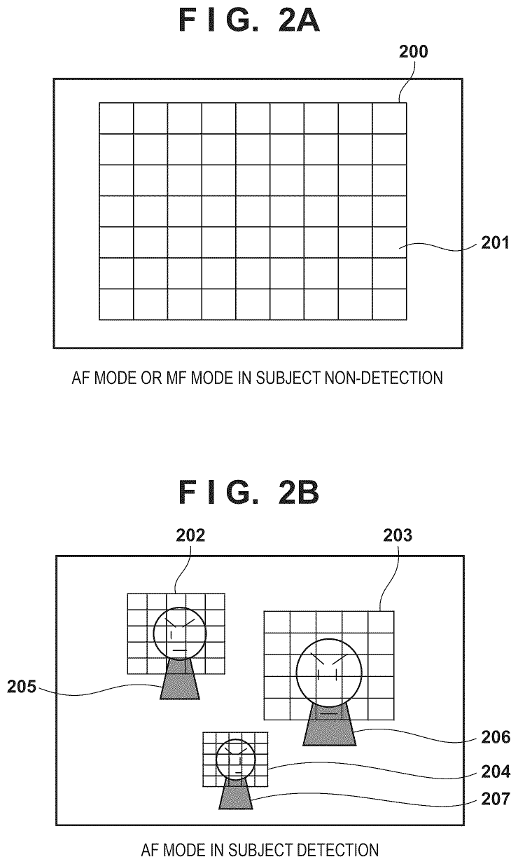

Next, a setting method of a ranging region by the ranging region setting unit 118 according to the present embodiment will be described with reference to FIGS. 2A to 2C.

FIGS. 2A to 2C illustrate a ranging region set by ranging region setting unit 118.

FIG. 2A illustrates a ranging region 201 set on an imaging screen 200 corresponding to image data generated by the image signal processing unit 108. The ranging region 201 includes a plurality of rectangular regions two-dimensionally arranged. Note that FIG. 2A illustrates a ranging region in a state where no subject is detected on the imaging screen 200, and the ranging region 201 is arranged as illustrated in FIG. 2A regardless of whether the focus mode of the image capture apparatus 100 is the AF mode, the MF mode, or the MF/AF switching mode.

FIG. 2B illustrates ranging regions 202 to 204 at the time of subject detection. A plurality of two-dimensional ranging regions corresponding to the center and size of the face are set for each of detected subjects 205 to 207. Note that FIG. 2B illustrates a ranging region in a state where the subject is detected, and illustrates an arrangement in a case where the focus mode of the image capture apparatus 100 is the AF mode or the MF/AF switching mode. The ranging region is arranged as illustrated in FIG. 2B in order to reduce focus blur in AF control on each detected subject.

FIG. 2C illustrates a ranging region 208 at the time of subject detection. In the example of FIG. 2C, a plurality of two-dimensional ranging regions are set for all detected subjects 209 to 211. Note that FIG. 2C illustrates a ranging region in a state where the subject is detected, and illustrates an arrangement in a case where the focus mode of the image capture apparatus 100 is the MF mode. The ranging region is arranged as illustrated in FIG. 2C so that the image capture apparatus 100 can efficiently specify a subject targeted by manual focus operation by the user, and the arrangement is similar to the state of FIG. 2A.

In this manner, by changing the ranging range according to the detection state of the subject and the focus mode, it is possible to specify the subject matching the user's intention and maintain the in-focus state for the target subject in the AF control.

The focus control unit 121 executes AF control based on at least one or more ranging results among a plurality of ranging results obtained from the ranging regions 201 to 204 illustrated in FIGS. 2A to 2C.

### AF Control Mode

Next, the AF control mode will be described.

The image capture apparatus 100 according to the present embodiment can execute the following plurality of AF control modes. The image capture apparatus 100 according to the present embodiment can be changed to the following first AF control mode, second AF control mode, or third AF control mode by a user operation.
First AF control mode: Center and closest distance priority AF
Second AF control mode: Face AF
Third AF control mode: Tracking AF

In the “First AF control mode: Center and closest distance priority AF”, AF control is executed with priority given to a subject positioned nearest to the center of the imaging screen and closest distance in the optical axis direction. The focus control unit 121 determines whether a subject positioned nearest to the center of the imaging screen and closest distance in the optical axis direction exists based on the subject detection result detected by the subject region detection unit 126 and the like. Then, when the ranging result of the subject positioned nearest to the center and closest distance can be obtained, the AF control is executed according to the ranging result of the subject positioned nearest to the center and closest distance. By this, the subject appearing nearest to the center of the imaging screen and closest distance in the optical axis direction is focused one after another, and thus, the AF control becomes highly versatile and can perform AF in various scenes.

In the “Second AF control mode: Face AF”, the position and size of the face region of a person as the main subject are decided based on the subject detection result detected by the subject region detection unit 126, and the AF control is executed while tracking the main subject so that the ranging result of the face region is always in an in-focus state. In a case where there are a plurality of faces in the imaging screen, the prioritized face is, for example, a face nearest to the center of the imaging screen and having a large size. By this, the image capture apparatus 100 automatically determines the priority order of the subject and performs the AF control according to the subject detection result in the imaging screen, which is effective in a case where a detected subject such as a face exists.

The “First AF control mode: Center and closest distance priority AF” and the “Second AF control mode: Face AF” are exclusively controlled, and when there is no detected subject in the “Second AF control mode: Face AF”, the mode is switched to the “First AF control mode: Center and closest distance priority AF”.

In the “Third AF control mode: Tracking AF”, AF control is executed while tracking the main subject selected by the user from the plurality of detected subjects in the imaging screen so as to maintain the in-focus state. For example, tracking AF is performed on the main subject such that the ranging result of the region corresponding to the position designated by the user is always in the in-focus state, for example, the user designates the position on the imaging screen, and decides the position and size of the subject from the color information of the designated position and the ranging result, or decides the position and size of the face from the detection result of the face selected by the user. By this, the AF control is continued only for the subject targeted by the user, and the image capture apparatus 100 does not change the subject, and therefore the AF control becomes highly dedicated.

The “First AF control mode: Center and closest distance priority AF” and the “Third AF control mode: Tracking AF” are exclusive controls, and in the “Third AF control mode: Tracking AF”, when there is no detected subject, the control mode is switched to the “First AF control mode: Center and closest distance priority AF”.

Since AF control is known, detailed description thereof will be omitted.

### Menu Setting

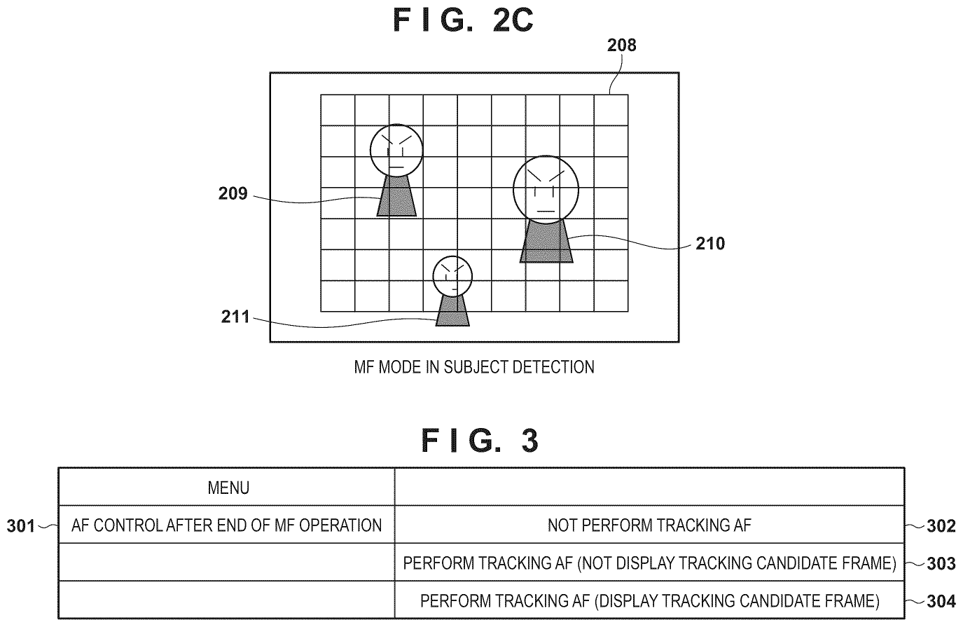

Next, a menu setting item according to the present embodiment will be described with reference to FIG. 3.

The menu according to the present embodiment includes a menu name 301. The menu name 301 is “AF control when MF operation ends”, and AF control after manual focus operation ends can be selected.

The menu 301 according to the present embodiment includes three options 302, 303, and 304. The first option 302 is a setting of “not performing tracking AF”. In a case where the first option 302 is selected, the tracking AF is not started after the manual focus operation ends. Specifically, in a case where the AF mode is set to the “First AF control mode: Center and closest distance priority AF” or the “Second AF control mode: Face AF”, the same AF control is maintained even after the manual focus operation ends, or the operation of the focus ring 124 is restricted.

The second option 303 is a setting of “performing tracking AF (not displaying tracking candidate frame)”. In a case where the second option 303 is selected, the tracking AF is started after the manual focus operation ends. Specifically, in a case where the AF mode is set to the “First AF control mode: Center and closest distance priority AF” or the “Second AF control mode: Face AF”, the AF mode is switched to the “Third AF control mode: Tracking AF” after the manual focus operation ends.

In the second option 303, in a case where the user operates the focus ring 124 to change to any of a plurality of detected subjects having a distance difference with respect to the image capture optical system 150, tracking AF is started for a target subject after the manual focus operation ends. This eliminates the need for the user to perform an operation of changing the AF control mode.

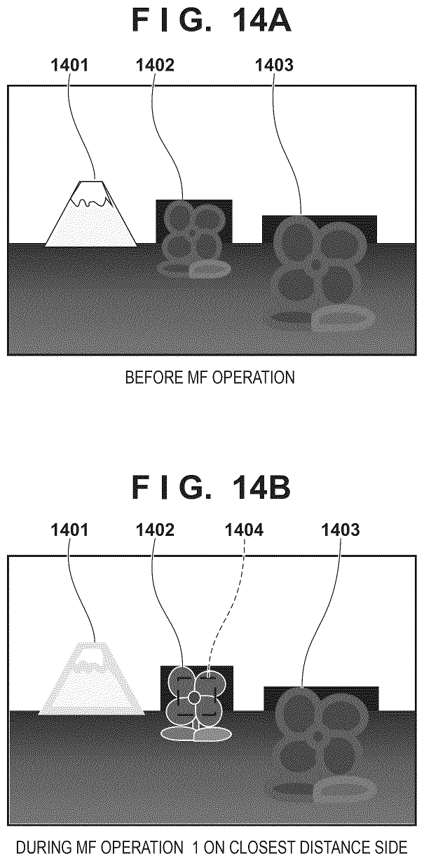

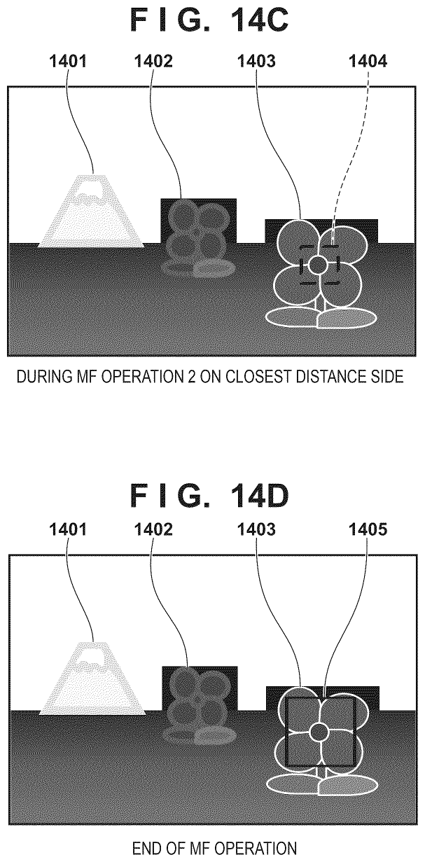

The third option 304 is a setting of “performing tracking AF (display tracking candidate frame)”. In the third option 304, switching of the AF control mode after the manual focus operation ends is the same as that in the second option 303. During the manual focus operation and after the manual focus operation ends, a tracking candidate frame is displayed on the main subject of the tracking target selected by the user with the focus ring 124. Although described later with reference to FIGS. 14A to 14D, the tracking candidate frame is displayed in a display form different from the tracking frame indicating that tracking AF is executed for the selected main subject after the manual focus operation ends. In the third option 304, the user can check whether the target subject is in a substantially in-focus state while operating the focus ring 124. In this manner, by presenting the user in advance a subject that is a target for tracking AF after the manual focus operation ends during the manual focus operation, it is possible to reduce failure in shooting.

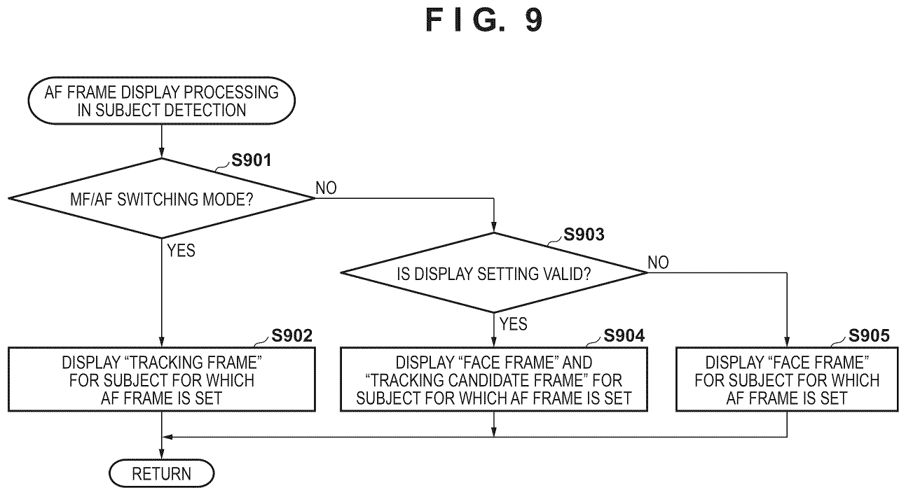

Note that details of the first option 302, the second option 303, and the third option 304 will be described later with reference to FIG. 9.

Method of Deciding Main Subject from Plurality of Detected Subjects

In the present embodiment, a main subject that is the tracking target for tracking AF can be decided from among a plurality of subjects detected by the subject region detection unit 126 by the following first subject decision method A or second subject decision method B.
First subject decision method A: Method of changing priority of subject
Second subject decision method B: Method of changing in-focus state of subject

“A: Method of changing priority of subject” is a method of assigning priority to a plurality of detected subjects according to the position and size of each subject and deciding the main subject by the user changing the priority. The user can change the priority order of the subject and decide the main subject by selecting the detected subject by a touch operation (not illustrated), a cross key operation, or an operation input of the control ring 125.

“B: Method of changing in-focus state of subject” is a method of deciding a subject in a substantially in-focus state as a main subject from a plurality of detected subjects by changing the subject in the in-focus state by the focus ring 124.

The image capture apparatus 100 according to the present embodiment can operate the first subject decision method A or the second subject decision method B by the following different operation members.
First subject decision method A: Control ring 125
Second subject decision method B: Focus ring 124

### Focus Ring 124 and Control Ring 125

In the image capture apparatus 100 according to the present embodiment, as illustrated in FIG. 1, the image capture optical system 150 includes the focus ring 124 and the control ring 125.

When the main subject is switched by the focus ring 124, the image capture apparatus 100 according to the present embodiment determines that the subject in the substantially in-focus state is the subject targeted by the user and executes the tracking AF, but in a case where a plurality of detected subjects exist at substantially the same distance with respect to the image capture optical system 150, the plurality of subjects are in the substantially in-focus state, and therefore it becomes difficult to determine the subject targeted by the user.

Therefore, in the present embodiment, when there are a plurality of detected subjects at substantially the same distance, the main subject can be switched by operating not the focus ring 124 but the control ring 125. By this, for example, similarly to other operation members (cross key and touch operation), the AF frame can be moved to the subject on the right side or the left side of the subject on which the current AF frame is displayed according to the rotation direction of the control ring 125.

In the present embodiment, the operation of the focus ring 124 is recommended when switching a plurality of detected subjects having a distance difference is performed, and the operation of the control ring 125 is recommended when switching a subject having no distance difference is performed.

This has two advantages.

The first advantage is that the user can select the target subject (subject with distance difference, subject with no distance difference) only with the left hand. In a known case where there are a plurality of detected subjects at substantially the same distance, it is necessary for the user to select the subject by operating the cross key or the like with the right hand. In the present embodiment, since the image capture optical system 150 includes two operation members of the focus ring 124 and the control ring 125, the user can select a target subject (subject with distance difference, subject with no distance difference) only by operating the operation member of the image capture optical system 150 held with the left hand.

The second advantage is that the user can control the rack focus speed at the time of switching the subject by operating the focus ring 124 recommended when selecting a subject having a distance difference, and thus the quality of the moving image is improved. On the other hand, in a case where a subject having no distance difference is selected, the quality of rack focus is not necessary, and thus the quality of the moving image is not affected only by switching the subject by operating the control ring 125.

### Focus Control Processing

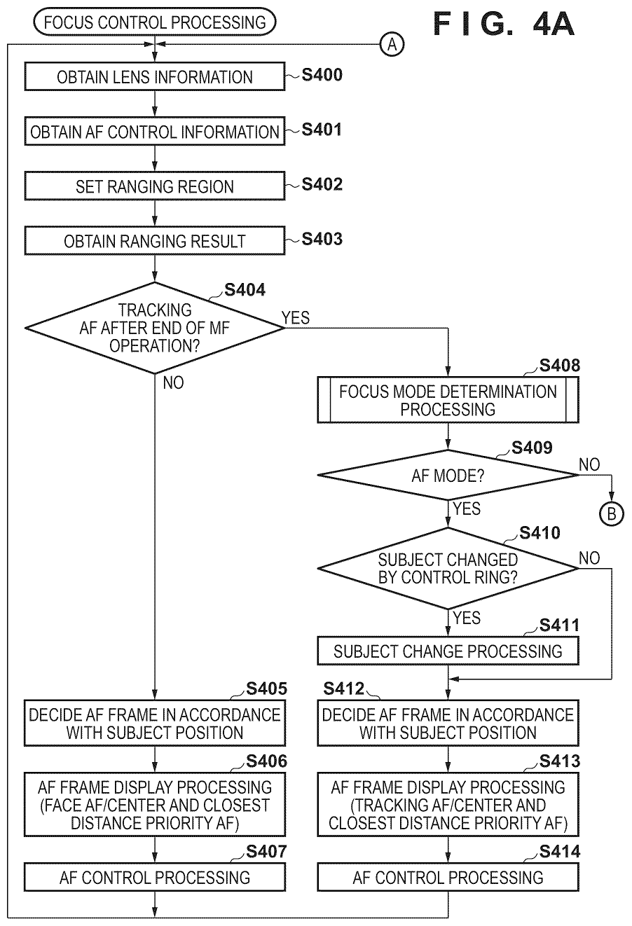

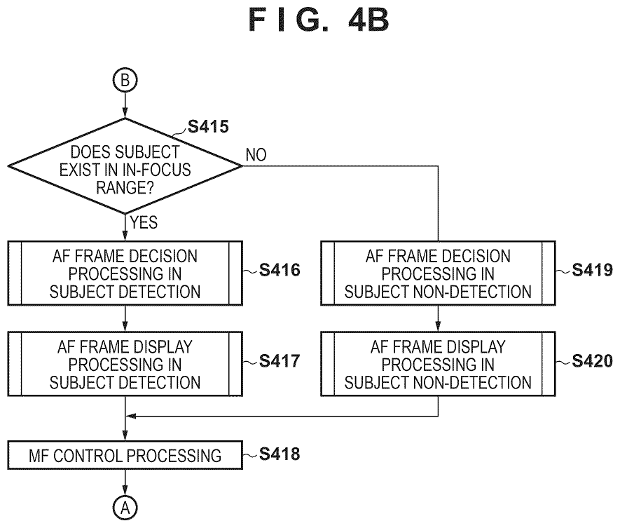

Next, the focus control processing according to the present embodiment will be described with reference to FIGS. 4A to 10.

The focus control processing according to the present embodiment is realized by the camera microcomputer 115 loading a program stored in the ROM into the RAM and executing the program, and controlling each component as the focus control unit 121.

First, a main flow of the focus control processing according to the present embodiment will be described with reference to FIGS. 4A and 4B.

The processing of FIGS. 4A and 4B is repeatedly executed according to a predetermined cycle, for example, a readout cycle of the image capture signal with respect to the imaging unit 106.

In step S400, the focus control unit 121 obtains the lens information of the image capture optical system 150, and proceeds with the processing to step S401. The lens information includes focal length information, subject distance information, diaphragm information, operation information of the focus ring 124, and operation information of the control ring 125.

In step S401, the focus control unit 121 obtains information regarding “AF control when focus operation ends” set by the user on the menu screen described with reference to FIG. 3, and proceeds with the processing to step S402.

In step S402, the focus control unit 121 sets the ranging region described with reference to FIGS. 2A to 2C, and proceeds with the processing to step S403.

In step S403, the focus control unit 121 obtains the ranging result from the in-focus position detection unit 119, and proceeds with the processing to step S404. In the present embodiment, it is assumed that results of all ranging regions set in FIGS. 2A to 2C are obtained.

In step S404, the focus control unit 121 determines whether or not the setting of “AF control after MF operation ends” obtained in step S401 is “tracking”, if the setting is “not tracking”, proceeds with the processing to step S405, and When the setting is “tracking”, proceeds with the processing to step S408.

In step S405, the focus control unit 121 performs processing of deciding an AF frame, and proceeds with the processing to step S406. When a face is detected, the focus control unit 121 performs face AF with a ranging region for the face as an AF frame. When the face is not detected, the focus control unit 121 sets a ranging region nearest to the center of the imaging screen and closest distance in the optical axis direction as the AF frame in a case where the ranging result nearest to the center of the imaging screen and closest distance in the optical axis direction can be obtained, and otherwise predicts the position of the subject from the current ranging result and the ranging region is the AF frame.

In step S406, the focus control unit 121 performs processing of displaying the AF frame, and proceeds with the processing to step S407. In a case where a face is detected, the focus control unit 121 displays an AF frame on the face, and otherwise it is center and closest distance priority AF with no AF frame displayed.

In step S407, the focus control unit 121 performs the AF control processing, returns the processing to step S400, and repeats the processing. The focus control unit 121 outputs control information for driving the focus lens 105 to the focus lens drive unit 112 according to the ranging result of the AF frame decided in step S405.

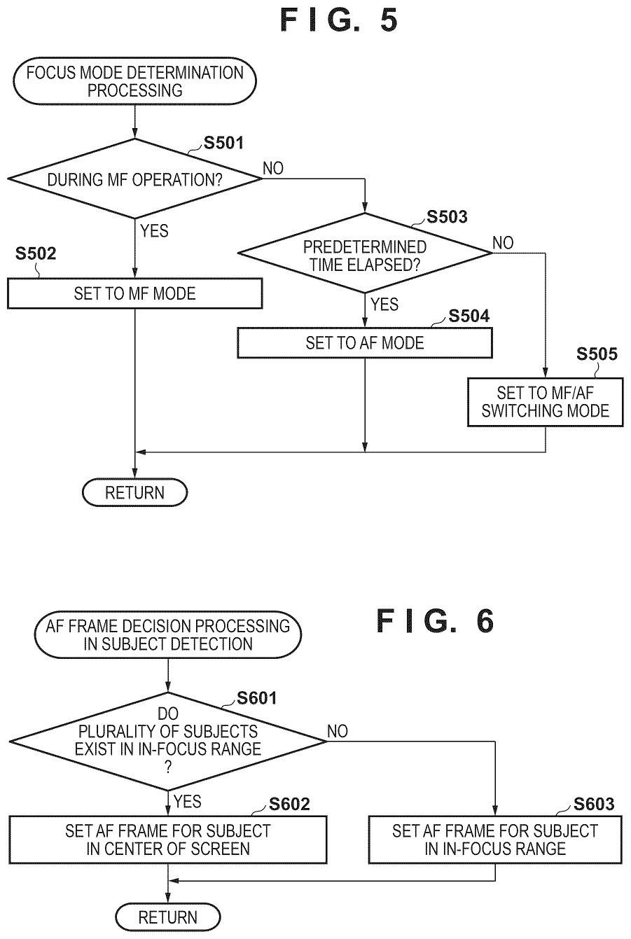

In step S408, the focus control unit 121 determines which of the “AF mode”, the “MF mode”, and the “MF/AF switching mode” the focus mode is, and proceeds with the processing to step S409. Details of the processing will be described later with reference to FIG. 5.

In step S409, the focus control unit 121 determines whether the focus mode is the “AF mode”. When it is the AF mode, the processing proceeds to step S410, and otherwise, the processing proceeds to step S415.

In step S410, the focus control unit 121 determines whether an instruction for changing the main subject has been received from the control ring 125, and when an operation has been received, proceeds with the processing to step S411, and otherwise, proceeds with the processing to step S412.

In step S411, the focus control unit 121 performs processing of changing the subject, and proceeds with processing to step S412. The user can notify the camera microcomputer 115 of a subject change instruction by rotating the control ring 125. In a case where a plurality of subjects are detected by the subject region detection unit 126 and in a case where a subject change instruction is given from the control ring 125, the focus control unit 121 changes the main subject according to the instruction.

For example, in FIG. 2B, in a case where the control ring 125 is rotated to the right and in a case where the face on which the AF frame is currently displayed is the detected subject 207, the AF frame moves to the detected subject 206 positioned on the right side. In a case where the control ring 125 is rotated to the left and in a case where the face on which the AF frame is currently displayed is the detected subject 207, the AF frame moves to the detected subject 205 positioned on the left side of the face on which the AF frame is displayed.

In step S412, the focus control unit 121 performs processing of deciding the AF frame, and proceeds with the processing to step S413. When tracking AF is being executed, the focus control unit 121 sets a ranging region of the tracking target as an AF frame. In a case where tracking AF is not being executed and in a case where a ranging result nearest to the center of the imaging screen and closest distance in the optical axis direction can be obtained, the focus control unit 121 sets the ranging region nearest to the center of the imaging screen and closest distance in the optical axis direction as an AF frame, and otherwise, predicts the position of the subject from the current ranging result, and sets the ranging region as an AF frame.

In step S413, the focus control unit 121 performs processing of displaying the AF frame, and proceeds with the processing to step S414. In a case where tracking AF is being executed, the focus control unit 121 displays an AF frame in a ranging region of the tracking target, and otherwise, it is the center and closest distance priority AF, and the AF frame is not displayed.

In step S414, the focus control unit 121 performs the AF control processing, returns the processing to step S400, and repeats the processing. The focus control unit 121 outputs control information for driving the focus lens to the focus lens drive unit 112 according to the ranging result of the AF frame decided in step S412.

In step S415, the focus control unit 121 determines whether or not the detected subject is present in the substantially in-focus range, and in a case where the detected subject is present, proceeds with the processing to step S416, and otherwise, proceeds with the processing to step S419.

In step S416, the focus control unit 121 performs AF frame decision processing at the time of subject detection, and proceeds with the processing to step S417. Details of the processing will be described later with reference to FIG. 6.

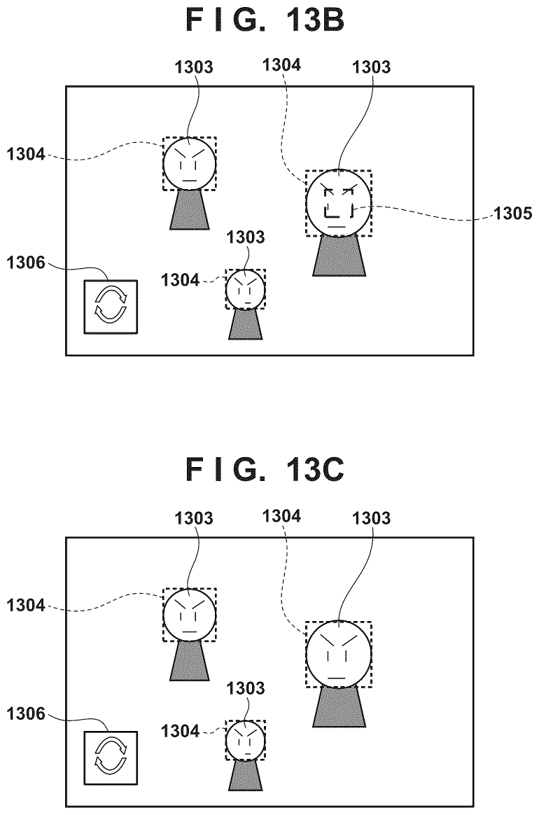

In step S417, the focus control unit 121 performs AF frame display processing at the time of subject detection, and proceeds with the processing to step S418. Details of the processing will be described later with reference to FIGS. 9 and 13A to 13C.

In step S418, the focus control unit 121 performs manual focus control processing, returns the processing to step S400, and repeats the processing. The focus control unit 121 outputs control information for driving the focus lens to the focus lens drive unit 112 based on the operation amount of the focus ring 124 or the operation amount of focus by a remote controller (not illustrated).

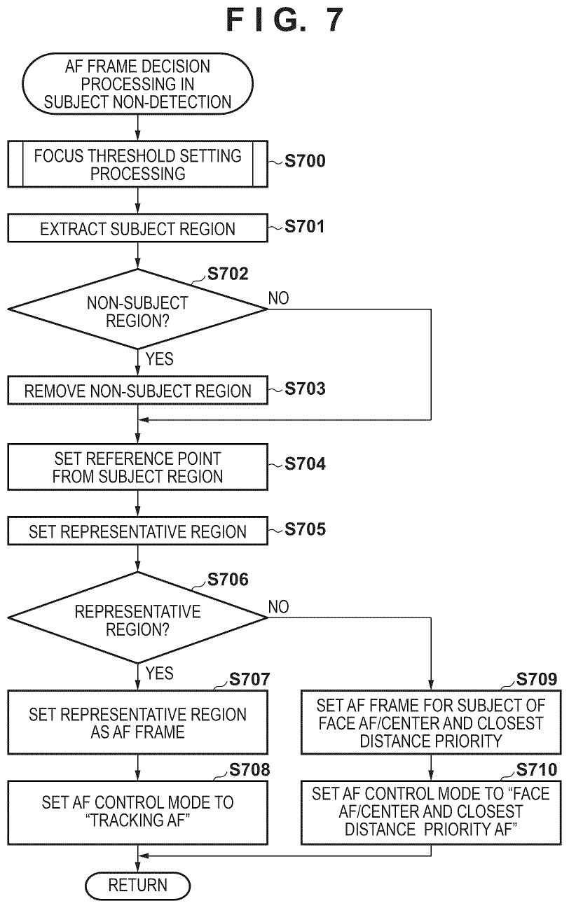

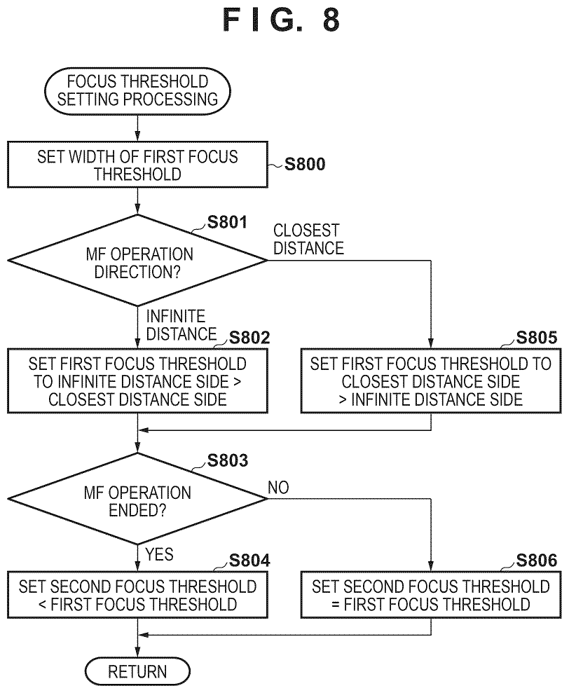

In step S419, the focus control unit 121 performs AF frame decision processing at the time of subject non-detection, and proceeds with the processing to step S420. Details of the processing will be described later with reference to FIGS. 7 and 8.

In step S420, the focus control unit 121 performs AF frame display processing at the time of subject non-detection, and proceeds with the processing to step S418. Details of the processing will be described later with reference to FIGS. 10 and 14A to 14D.

### Focus Mode Determination Processing

Next, the focus mode determination processing in step S408 in FIG. 4A will be described with reference to FIG. 5.

In step S501, the focus control unit 121 determines whether a manual focus operation with the focus ring 124 is performed or whether a manual focus operation for driving the focus lens 105 is performed with the remote controller (not illustrated). In a case where the manual focus operation is performed, the focus control unit 121 proceeds with the processing to step S502, and otherwise, proceeds with the processing to step S503.

In step S502, the focus control unit 121 sets the focus mode to the “MF mode” and ends the processing.

In step S503, the focus control unit 121 determines whether a predetermined time has elapsed from the end of the manual focus operation, and in a case where the predetermined time has elapsed, proceeds with the processing to step S504, and otherwise, proceeds with the processing to step S505. In the present embodiment, the predetermined fixed time is set to, for example, 0.6 seconds.

In step S504, the focus control unit 121 determines that the manual focus operation has ended, sets the focus mode to the “AF mode”, and ends the processing.

In step S505, the focus control unit 121 determines that manual focus operation is being performed, sets the focus mode to the “MF/AF switching mode” as preparation for switching from the MF mode to the AF mode, and ends the processing.

There is also a method of switching between AF and MF before the manual focus operation. However, in the present embodiment, in order to seamlessly perform AF and MF, the focus mode is changed to the AF mode depending on whether or not the manual focus operation has ended.

### AF Frame Decision Processing

Next, AF frame decision processing at the time of subject detection in step S416 in FIG. 4B will be described with reference to FIG. 6.

In step S601, the focus control unit 121 determines whether a plurality of detected subjects exist in a substantially in-focus range. In a case where the plurality of detected subjects do not exist in the substantially in-focus range, the focus control unit 121 proceeds with the processing to step S603, and sets the AF frame for one detected subject in the substantially in-focus range. In a case where the plurality of detected subjects exist in the substantially in-focus range, the focus control unit 121 proceeds with the processing to step S602, and sets the AF frame for the detected subject positioned nearest to the center of the imaging screen and closest distance in the optical axis direction. Note that the decision method of the AF frame is not limited to the example of FIG. 6, and in a case where the plurality of detected subjects exist in the substantially in-focus range, the AF frame may be set for the detected subject nearest to the in-focus state or the detected subject nearest to the center of the screen.

Next, the AF frame decision processing at the time of subject non-detection in step S419 of FIG. 4B will be described with reference to FIG. 7.

In step S700, the focus control unit 121 performs processing of setting the first focus threshold and the second focus threshold, and proceeds with the processing to step S701. The first focus threshold is a threshold of focus information for extracting a subject region from the ranging result obtained in step S403 in FIG. 4A. The second focus threshold is a threshold of focus information for setting a representative region from the main subject region extracted based on the first focus threshold. The representative region is a region set when the user changes the subject in the in-focus state by the focus ring 124, and is set as an AF frame for performing AF control after the manual focus operation ends, for example. During the manual focus operation, the representative region is set as a tracking candidate frame at the time of AF start in step S420 in FIG. 4B. Details of the setting method of the first focus threshold and the second focus threshold will be described later with reference to FIG. 8.

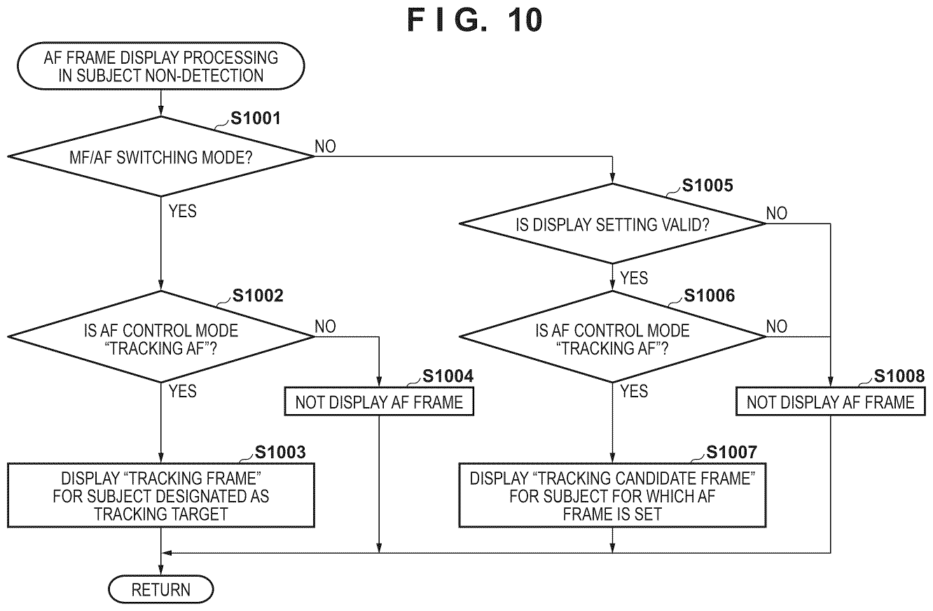

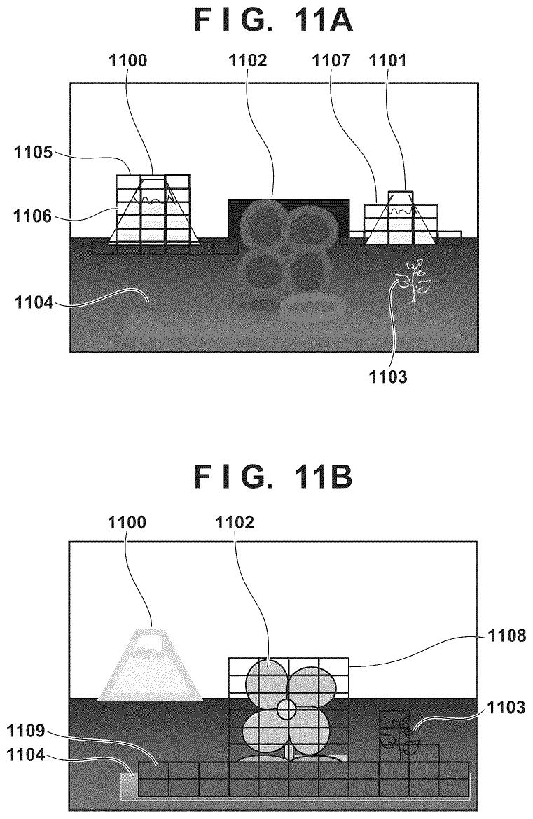

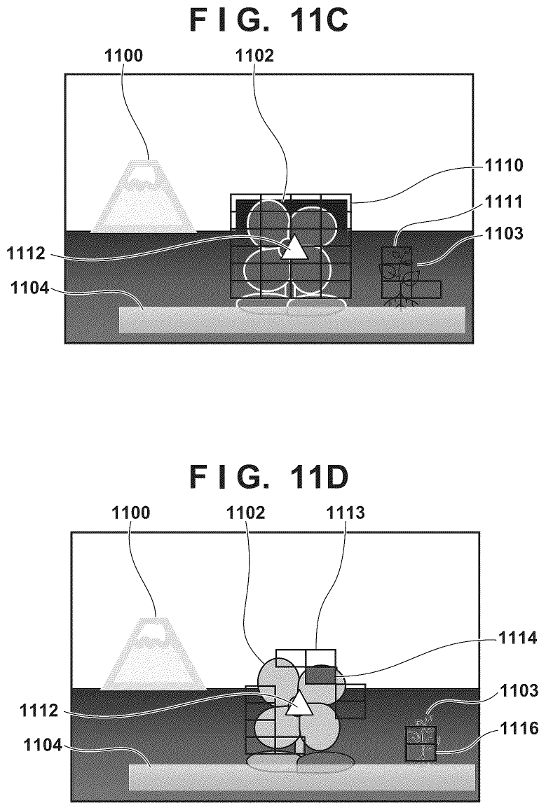

In step S701, the focus control unit 121 performs processing of extracting a subject region based on the first focus threshold set in step S700, and proceeds with the processing to step S702. Here, an extraction method of a subject region at the time of subject non-detection according to the present embodiment will be described with reference to FIG. 11A. In the example of FIG. 11A, subjects 1100 to 1104 are an object or the ground, the object 1100 and the object 1101 are positioned at substantially the same distance with respect to the image capture optical system 150, the object 1102 and the object 1103 are positioned nearest to the center of the imaging screen and closest distance in the optical axis direction as viewed from the object 1100, and the ground 1104 is positioned at substantially the same distance. Then, first focus information 1105 is first focus information decided based on the first focus threshold set in step S700 in the ranging result obtained in step S403 in FIG. 4A. A subject region 1106 is an extracted subject region, and the extraction method is to extract as one subject region, for example, in a case where the respective pieces of focus information 1105 are adjacent. The extraction method may be a method of extracting the subject region by color, luminance, or the like. In a case where there are a plurality of objects within the range of the first focus threshold, such as the object 1100 and the object 1101, in a case where the focus information 1105 is not adjacent, such as the subject region 1106 and a subject region 1107, it can be extracted as another subject region.

In step S702, the focus control unit 121 determines whether there is a non-subject region in the subject region extracted in step S701, and in a case of determining that there is a non-subject region, proceeds with the processing to step S703, and otherwise, proceeds with the processing to step S704. Here, a determination method of a non-subject region according to the present embodiment will be described with reference to FIG. 11B. FIG. 11B illustrates a state in which the user operates the focus ring 124 to the nearest to the center of the imaging screen and closest distance in the optical axis direction from the focus state of FIG. 11A, and the object 1102, the object 1103, and the ground 1104 are in the in-focus state. A region 1108 is a set region of the first focus information at the time of operating the focus ring 124, and the object 1102, the object 1103, and the ground 1104 are extracted as one subject region. In this manner, for example, in a case where subject regions of different objects are continuous with a ground region interposed, they are extracted as one subject region. In order to extract this one subject region 1108 as separate subject regions, when a part of the ground region of the subject region is larger than a predetermined proportion with respect to the imaging screen as in a region 1109, it is determined as a non-subject region and removed. This non-subject region is, for example, a ground region continuous with the subject region, and may be a wall, a ceiling, or the like.

In step S703, the focus control unit 121 performs processing of removing the non-subject region, and proceeds with the processing to step S704. Here, a method of removing the non-subject region according to the present embodiment will be described with reference to FIG. 11C. FIG. 11C illustrates a state in which the non-subject region 1109 determined in step S702 is removed from the subject region 1108 in FIG. 11B. By removing the non-subject region 1109 from the subject region 1108, one adjacent subject region 1108 is divided into non-adjacent subject regions 1110 and 1111, and thus can be extracted as separate subject regions. In this manner, by removing the non-subject region, the extraction accuracy of the subject region is improved, and the non-subject region is not selected in the AF frame decision processing.

In step S704, the focus control unit 121 performs processing of setting a reference point from the subject region from which the non-subject region has been removed in step S703, and proceeds with the processing to step S705. Here, a method of setting the reference point from the subject region after the non-subject region is removed according to the present embodiment will be described with reference to FIG. 11C. First, the main subject region is decided from the subject region 1110 and the subject region 1111 remaining after the non-subject region is removed in step S703. In the method of deciding the main subject region, when the plurality of subject regions are extracted, for example, the largest subject region is decided as the main subject region, or the subject region at the center of the screen is decided as the main subject region. When only one subject region is extracted, the subject region is decided as the main subject region. When no subject region is extracted, the main subject region is not decided. Next, after the main subject region is decided, a reference point 1112 is set from the main subject region. The reference point 1112 may be set to, for example, a barycentric position of the main subject region or a position nearest to the center of the imaging screen and closest distance in the optical axis direction.

In step S705, the focus control unit 121 sets the representative region based on the reference point of the subject decided in step S704 and the second focus threshold set in step S700, and proceeds with the processing to step S706. Here, a method of setting the representative region according to the present embodiment will be described with reference to FIG. 11D. A region 1113 is second focus information decided based on the second focus threshold set in step S700. A region 1114 is a representative region. First, since the representative region 1114 is selected from among the second focus information 1113, which is an in-focus range, when the representative region 1114 is set to the AF frame in step S707, the AF control can be started from the focus position in the in-focus range. By this, when the AF control is started after the manual focus operation ends, it is not necessary to consider the continuation between the operation speed of the focus ring 124 of the user and the speed of the AF control, and the variation amount of the focus position is small, and therefore the quality of the moving image is not lowered. Next, a method of selecting the representative region 1114 from the second focus information 1113 will be described. The second focus information may be, for example, a region including a large amount of background around the object 1102 as in the focus information 1113, or a region included in the object 1103 as in the focus information 1116. Hence, when the representative region 1114 is selected from the second focus information, there is a possibility that the outside of the region of the object 1102, which is the main subject region set in step S704, is selected. In order to avoid this, when the representative region 1114 is selected from the second focus information 1113, the reference point set in step S704 is set in the region having the shortest distance in a xy plane. In this manner, by setting the region having the shortest distance with respect to the reference point and included in a second focus information as the representative region, a region different from the main subject region will not be set as the representative region.

In step S706, the focus control unit 121 determines whether the representative region obtained in step S705 exists, and when the representative region exists, proceeds with the processing to step S707, and otherwise, proceeds with the processing to step S709.

In step S707, the focus control unit 121 sets the representative region as the AF frame, and proceeds with the processing to step S708.

In step S709, the focus control unit 121 sets the AF frame in a case where the representative region does not exist in step S706, and proceeds with the processing to step S710. In a case where the face is detected, the focus control unit 121 sets a ranging region for the face as an AF frame and performs face AF. In a case where the face is not detected, the focus control unit 121 sets a ranging region as an AF frame if there is a ranging result nearest to the center of the imaging screen and closest distance in the optical axis direction, and otherwise, predicts the position of the subject from a current ranging result, and sets the ranging region as an AF frame.

In step S708, the focus control unit 121 sets the AF control mode to “tracking AF”, and proceeds with the processing to step S420 in FIG. 4B.

In step S710, the focus control unit 121 sets the AF control mode to “face AF/center and closest distance priority AF”, and proceeds with the processing to step S420 in FIG. 4B.

### Setting Processing of First Focus Threshold and Second Focus Threshold

Next, setting processing of the first focus threshold and the second focus threshold in step S700 of FIG. 7 will be described with reference to FIG. 8.

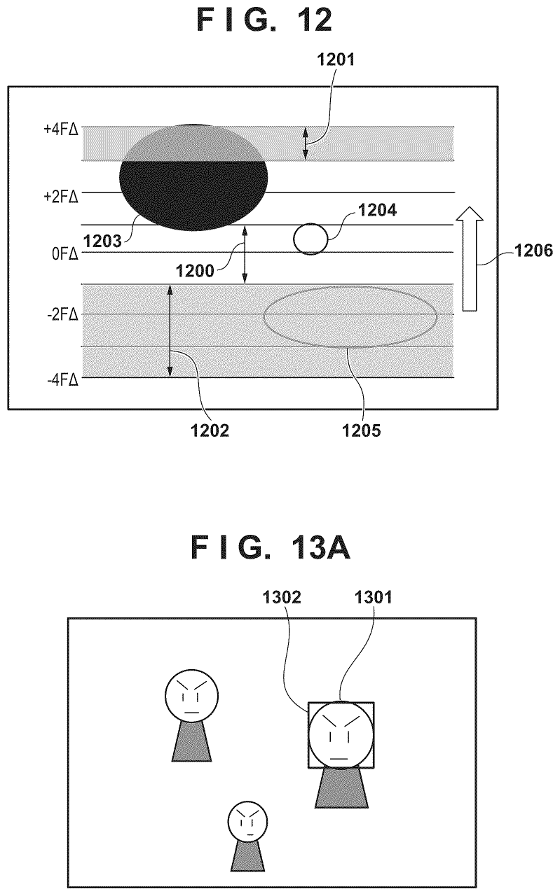

In step S800, the focus control unit 121 performs processing of setting an upper limit and a lower limit, which are a width of the first focus threshold, based on the lens information obtained in step S400 in FIG. 4A, and proceeds with the processing to step S801. Here, the setting method of the width of the first focus threshold according to the present embodiment will be described with reference to FIG. 12. In FIG. 12, the vertical axis indicates the depth of field, and 0 indicates the in-focus position, and the larger the number, the farther from the in-focus position. FA is a unit of in-focus, and in the present embodiment, a range in which the depth of field is −1FΔ to 1FΔ is set as the in-focus range. Note that the in-focus range represents the range of a depth of field that appears to be in focus, and is a range in which a front in-focus distance (closest distance side) and a rear in-focus distance (infinite distance side) are added to an in-focus position (OFA).

A region 1200 indicates a range of the first focus threshold, and a region 1201 and a region 1202 indicate outside the range of the first focus threshold. Regions 1203 to 1205 indicate objects, indicating that the object 1203 and the object 1204 are objects within the range of the first focus threshold, and indicating that the object 1205 is an object outside the range of the first focus threshold. In the present embodiment, the first focus threshold is set in a range of −1FΔ to 3FΔ, and is set to include not only the in-focus range (−1FΔ to 1FΔ) but also the non-in-focus range (1FΔ to 3FΔ). Note that in the present embodiment, the first focus threshold is the depth of field, but may be a value based on the subject distance. In this manner, by setting the first focus threshold including the non-in-focus range, for example, an object slightly shifted from the in-focus range but having a large presence such as the object 1203 can be extracted as a large subject region in step S701 in FIG. 7. By extracting a large subject region, the possibility of being selected when the main subject is decided in step S704 of FIG. 7 is improved. On the other hand, since the object extracted by enlarging the subject region is selected as the main subject region, it is possible to prevent an object (e.g., a small object such as a stone) that is within the in-focus range but is not desired to be selected as the main subject, such as the object 1204, from being selected. By setting the first focus threshold including the outside of the in-focus range, even in a case where the focus position slightly shifts from the in-focus range when the user focuses on the target object with the focus ring 124, the target object can be extracted as a large subject region. On the other hand, when the first focus threshold is set to the in-focus range (−1FΔ to 1FΔ) and the subject region is extracted, the size of the extracted subject region becomes small. For this reason, when the focus position when the user ends the operation of the focus ring 124 is slightly shifted from the target object, the relative size of the subject region of the target object is changed, and there is a possibility that a ground region or another small subject region at substantially the same distance is selected as the main subject region.

In step S801, the focus control unit 121 determines the operation direction of the focus ring 124. The focus control unit 121 proceeds with the processing to step S802 in a case where the focus ring 124 is operated to the infinite distance side in the optical axis direction, and proceeds with the processing to step S805 in a case where the focus ring 124 is operated to the nearest to the center of the imaging screen and closest distance in the optical axis direction.

In step S802, the focus control unit 121 sets the first focus threshold based on the operation direction (infinite distance side) of the focus ring 124 in step S801 and the width of the first focus threshold set in step S800. Here, a method of setting the first focus threshold according to the present embodiment will be described with reference to FIG. 12. Arrow 1206 indicates the operation direction of the focus ring 124. The region 1200 indicates being within the range of the first focus threshold. In the example of FIG. 12, the range 1200 of the first focus threshold is divided into a range on the closest distance side and a range on the infinite distance side with the in-focus position (OFA) as a boundary, and the proportion of the threshold on the infinite distance side, which is the operation direction 1206 of the focus ring 124, is set to be larger than the proportion of the threshold on the closest distance side. In this manner, by increasing the proportion of the range of the first focus threshold in the operation direction 1206 of the focus ring 124, it is possible to exclude, from the options, the object on the closest distance side to the focus position when the user ends the operation of the focus ring 124. On the other hand, when the AF control is executed on the main subject without excluding the object on the closest distance side, there is a possibility that the focus position varies in a direction opposite to the operation direction 1206 of the focus ring 124. Hence, by increasing the proportion of the first focus threshold in the operation direction 1206 of the focus ring 124, the subject region can be largely extracted without the focus position varying in the direction opposite to the operation direction 1206 of the focus ring 124.

In step S805, the focus control unit 121 sets the first focus threshold based on the operation direction (closest distance side) of the focus ring 124 in step S801 and the width of the first focus threshold set in step S800. In this case, since the operation direction of the focus ring 124 is on the closest distance side, the range of the first focus threshold is set such that the proportion on the closest distance side is larger than that on the infinite distance side.

In step S803, the focus control unit 121 determines whether the operation of the focus ring 124 ends, and in a case of determining that the operation of the focus ring 124 ends, proceeds with the processing to step S804, and otherwise, proceeds with the processing to step S806. The focus control unit 121 determines that the operation of the focus ring ends when the operation speed of the focus ring 124 is deceleration, and determines that the focus ring is being operated when the operation speed of the focus ring 124 is acceleration or constant.

In step S804, in a case of determining in step S803 that the operation of the focus ring 124 ends, the focus control unit 121 performs processing of setting the second focus threshold, and proceeds with the processing to step S701 in FIG. 7. In this case, the second focus threshold is set to a value smaller than the first focus threshold set in step S800, for example. This is because, in a case where the user ends the operation of the focus ring 124, an operation of focusing on a target subject is performed, and it is expected that the focus position does not vary after the user ends the operation of the focus ring 124. Hence, by setting, within the in-focus range, the representative region set in step S705 in FIG. 7, the variation amount of the focus position after the end of the operation of the focus ring 124 becomes small, and the AF control can be executed on the main subject without lowering the quality of the moving image.

In step S806, in a case where it is determined in step S803 that the focus ring 124 is being operated, the focus control unit 121 performs processing of setting the second focus threshold, and proceeds with the processing to step S701 in FIG. 7. In this case, the second focus threshold is set to the same value as the first focus threshold set in step S800. During the operation of the focus ring 124, it is not necessary to set the representative region from the in-focus range, and the reference point set in step S704 is set as the representative region. By this, for example, when the reference point is the barycenter of the subject region, the tracking candidate frame at the time of AF start can be displayed at the barycentric position of the subject region in step S420 in FIG. 4B. When the position of the tracking candidate frame at the time of AF start displayed in step S420 in FIG. 4B is set to, for example, the barycentric position of the subject region, the user can easily grasp the AF start position after the end of the operation of the focus ring 124.

### AF Frame Display Processing

Next, AF frame display processing at the time of subject detection in step S417 in FIG. 4B will be described with reference to FIG. 9.

In step S901, the focus control unit 121 determines the focus mode, and in a case where the mode is the “MF/AF switching mode”, proceeds with the processing to step S902, and otherwise, proceeds with the processing to step S903.

In step S902, the focus control unit 121 displays a tracking face frame illustrated in FIG. 13A for the detected subject for which the AF frame is set in step S416 of FIG. 4B in a case where the user has ended operation of the focus ring 124. In the example of FIG. 13A, a tracking frame 1302 indicating that tracking AF is executed for a detected subject 1301 for which the AF frame is set in step S416 of FIG. 4B is displayed.

In step S903, the focus control unit 121 determines whether the tracking candidate frame display setting is valid, and in a case where the tracking candidate frame display setting is valid, proceeds with the processing to step S904, and in a case where it is invalid, proceeds with the processing to step S905.

In step S904, the focus control unit 121 displays a face frame 1304 and a tracking candidate frame 1305 illustrated in FIG. 13B for the detected subject for which the user is operating the focus ring 124 and the AF frame is set in step S416 of FIG. 4B. In the example of FIG. 13B, the face frame 1304 indicating a detected subject in a substantially in-focus range is displayed on a detected subject 1303 for which the AF frame is set in step S416 of FIG. 4B. The tracking candidate frame 1305 indicating a tracking candidate is displayed at the main subject designated by the user operating the control ring 125 among the plurality of detected subjects 1303 in the substantially in-focus range.

In step S905, the focus control unit 121 displays the face frame 1304 illustrated in FIG. 13C for the detected subject for which the AF frame is set in step S416 of FIG. 4B. In the example of FIG. 13C, the face frame 1304 indicating a detected subject in a substantially in-focus range is displayed on the detected subject 1303 for which the AF frame is set in step S416 of FIG. 4B. Since the tracking candidate frame display setting is not valid, the tracking candidate frame 1305 is not displayed on the main subject designated by the user operating the control ring 125 among the plurality of detected subjects 1303.

Note that the tracking frame, the face frame, and the tracking candidate frame are displayed in different forms so as to be identifiable by the user.

In a case where a plurality of detected subjects exist in the substantially in-focus range in step S601 of FIG. 6, an icon 1306 is displayed as illustrated in FIGS. 13B and 13C. This prompts the user to operate the control ring 125, and notifies the user that the main subject cannot be changed with the focus ring 124. In place of notification by the icon 1306, the notification may be performed by continuously displaying the tracking candidate frame at the AF frame position decided in step S602 of FIG. 6 and restricting switching of the subject.

Next, AF frame display processing at the time of subject non-detection in step S420 in FIG. 4B will be described with reference to FIG. 10.

In step S1001, the focus control unit 121 determines the focus mode, and in a case where the mode is the “MF/AF switching mode”, proceeds with the processing to step S1002, and otherwise, proceeds with the processing to step S1005.

In step S1002, the focus control unit 121 determines whether the AF control mode is the “tracking AF”, and in a case where the AF control mode is the “tracking AF”, proceeds with the processing to step S1003, and otherwise, proceeds with the processing to step S1004.

In step S1003, the focus control unit 121 displays the tracking frame on the main subject designated by the user with the manual focus operation in step S418 of FIG. 4B in a case where the user has ended the operation of the focus ring 124.

In step S1004, the focus control unit 121 does not display the tracking frame.

In step S1005, the focus control unit 121 determines whether the tracking candidate frame display setting is valid, and in a case where the tracking candidate frame display setting is valid, proceeds with the processing to step S1006, and in a case where it is invalid, proceeds with the processing to step S1008.

In step S1006, the focus control unit 121 determines whether the AF control mode is the “tracking AF”, and in a case where the AF control mode is the “tracking AF”, proceeds with the processing to step S1007, and otherwise, proceeds with the processing to step S1008.

In step S1007, the focus control unit 121 displays a tracking candidate frame indicating that the user is operating the focus ring 124 and the subject for which the AF frame is set in step S419 of FIG. 4B is a tracking target.

In step S1008, the focus control unit 121 does not display the tracking frame.

FIG. 14 is a view illustrating an AF frame display method at the time of subject non-detection according to the present embodiment.

FIGS. 14A to 14D illustrate transitions of the display state of the AF frame from before to during and after the operation of the focus ring 124. Subjects 1401 to 1403 illustrated in FIG. 14 each indicate a subject not detected by the subject region detection unit 126, and it is assumed that the subject 1401 is on the infinite distance side, the subject 1402 is closer to the closest distance side than the subject 1401, and the subject 1403 is closer to the closest distance side than the subject 1402.

FIG. 14A illustrates an imaging screen before the focus ring 124 is operated. In the example of FIG. 14A, since the subject is not detected and the AF mode is set, no AF frame is displayed as described in FIG. 2A.

FIG. 14B illustrates the imaging screen during the operation of the focus ring 124. In the example of FIG. 14B, an AF frame is set in the subject 1402 by the AF frame decision processing of step S419 of FIG. 4B, and a tracking candidate frame 1404 indicating a candidate for a tracking target is superimposed and displayed on the subject 1402 at the time of tracking start.

FIG. 14C illustrates the imaging screen during the operation of the focus ring 124 when the manual focus operation is performed on a subject yet closer to the closest distance side than that in FIG. 14B. Similarly to FIG. 14B, in FIG. 14C, the AF frame is set in the subject 1403 by the AF frame decision processing in step S419 in FIG. 4B, and tracking candidate frame 1404 is superimposed and displayed on the subject 1403.

Note that in a state where the subjects in FIGS. 14A to 14C are not detected, the icon 1306 may be displayed as in FIGS. 13B and 13C to notify the user that the main subject can be changed by the focus ring 124.

FIG. 14D illustrates the imaging screen after the operation end of the focus ring 124. In the example of FIG. 14D, the focus mode is the “MF/AF switching mode”, and the AF control after the MF operation ends is the “tracking AF”, and a tracking frame 1405 indicating that the tracking AF is to be executed for the subject 1403, which had been a tracking candidate in FIG. 14C, is superimposed and displayed.

Note that in the present embodiment, an example where the tracking candidate frame 1404 is a square frame in the dashed line, and the tracking frame 1405 is a square frame in the solid line, but the present disclosure is not limited to this, and the shape, color, size, and the like of the frame may be changed. For example, the tracking candidate frame 1404 may be an orange double key frame, and the size may be displayed as a fixed size, and the tracking frame 1405 may be a white double rectangular frame, and the size may be variable according to the size of the subject.

According to the present embodiment, by superimposing and displaying the tracking frame and the tracking candidate frame at the AF frame position set by the manual focus operation at the time of subject non-detection, the user can easily grasp the subject of the tracking target during the manual focus operation and after the manual focus operation ends.

According to the present disclosure, it is possible to easily grasp a main subject that is a target for AF control selected by a user operation.

### OTHER EMBODIMENTS

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to exemplary embodiments, it is to be understood that the present disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2024-089246, filed May 31, 2024 which is hereby incorporated by reference herein in its entirety.

What is claimed is:

1. A control apparatus comprising:
a display control unit that performs control so as to display a captured image on a display unit; and
a control unit that performs automatic focus control on a predetermined subject selected based on a user operation for changing an in-focus state of a subject included in the image,
wherein the display control unit performs control so as to superimpose and display, on the predetermined subject, first information indicating that the predetermined subject is a target for the automatic focus control,
the automatic focus control is switchable to any of a plurality of automatic focus controls including tracking AF that causes a subject of a target for the automatic focus control to be always in an in-focus state, and
when the automatic focus control is set to the tracking AF, the control unit executes the tracking AF on the predetermined subject after the user operation ends.

2. The control apparatus according to claim 1, wherein
the display control unit performs control so as to superimpose and display the first information on the predetermined subject until the user operation ends.

3. The control apparatus according to claim 1, further comprising
a setting unit that sets whether or not to execute the tracking AF on the predetermined subject after the user operation ends,
wherein when the setting unit performs setting so as to execute the tracking AF, the control unit executes the tracking AF on the predetermined subject after the user operation ends.

4. The control apparatus according to claim 1, further comprising
a detection unit that detects a subject from the captured image,
wherein when the detection unit detects no subject, the display control unit performs control so as to display, in a first form, the first information on the predetermined subject selected by the user operation while the user operation is being performed.

5. The control apparatus according to claim 4, wherein
the display control unit performs controls so as to display, in a second form different from the first form, the first information on the predetermined subject selected by the user operation after the user operation ends.

6. The control apparatus according to claim 1, wherein
the first information is information indicating that the predetermined subject is a target of the tracking AF.

7. The control apparatus according to claim 3, wherein
whether or not to display the first information can be set when the tracking AF is set to be executed on the predetermined subject after the user operation ends, and
the display control unit performs control so as to superimpose and display the first information on the predetermined subject in a case of setting to display the first information.

8. The control apparatus according to claim 1, wherein
when the automatic focus control is not set to the tracking AF, the display control unit performs control so as not to display the first information on the predetermined subject.

9. The control apparatus according to claim 1, wherein
the first information is a frame surrounding a subject.

10. The control apparatus according to claim 1, further comprising
a detection unit that detects a subject from the captured image,
wherein in a case of setting in which the detection unit detects a plurality of subjects and the first information is displayed, the display control unit performs control so as to superimpose and display second information in a form different from the first information on the plurality of subjects while the user operation is being performed, and superimpose and display, in a first form, the first information together with the second information on a subject selected from the plurality of subjects.

11. The control apparatus according to claim 10, wherein
the display control unit performs control so as to display, in a second form different from the first form, the first information on a subject selected from the plurality of subjects after the user operation ends.

12. The control apparatus according to claim 10, wherein
the plurality of subjects include subjects having a same in-focus distance.

13. The control apparatus according to claim 11, wherein
the second information is a frame surrounding a subject.

14. The control apparatus according to claim 4, wherein
when the detection unit detects no subject, the control unit extracts a subject region based on a first threshold with respect to focus information obtained from the image in response to the user operation, and decides the predetermined subject by setting a representative region from the subject region based on a second threshold.

15. The control apparatus according to claim 14, wherein
the first threshold is set such that, when the user operation is on an infinite distance side in an optical axis direction, a range on the infinite distance side is larger than a range on a closest distance side,
the first threshold is set such that, when the user operation is on the closest distance side in an optical axis direction, a range on the closest distance side is larger than a range on the infinite distance side,
the second threshold is set to a same value as the first threshold until the user operation ends, and
the second threshold is set to a value smaller than the first threshold after the user operation ends.

16. An image capture apparatus comprising:
an imaging unit that captures a subject image formed by an optical system; and
a control apparatus comprising:
a display control unit that performs control so as to display a captured image on a display unit; and
a control unit that performs automatic focus control on a predetermined subject selected based on a user operation for changing an in-focus state of a subject included in the image,
wherein the display control unit performs control so as to superimpose and display, on the predetermined subject, first information indicating that the predetermined subject is a target for the automatic focus control,
the automatic focus control is switchable to any of a plurality of automatic focus controls including tracking AF that causes a subject of a target for the automatic focus control to be always in an in-focus state, and
when the automatic focus control is set to the tracking AF, the control unit executes the tracking AF on the predetermined subject after the user operation ends.

17. A control method of a control apparatus comprising:
performing automatic focus control on a predetermined subject selected based on a user operation for changing an in-focus state of a subject included in a captured image; and
performing control so as to superimpose and display, on the predetermined subject, first information indicating that the predetermined subject is a target for the automatic focus control.

18. A non-transitory computer-readable storage medium storing a program for causing a computer to function as a control apparatus comprising:
a display control unit that performs control so as to display a captured image on a display unit; and
a control unit that performs automatic focus control on a predetermined subject selected based on a user operation for changing an in-focus state of a subject included in the image,
wherein the display control unit performs control so as to superimpose and display, on the predetermined subject, first information indicating that the predetermined subject is a target for the automatic focus control,
the automatic focus control is switchable to any of a plurality of automatic focus controls including tracking AF that causes a subject of a target for the automatic focus control to be always in an in-focus state, and
when the automatic focus control is set to the tracking AF, the control unit executes the tracking AF on the predetermined subject after the user operation ends.
